(19) United States
(12) Patent Application Publication
(10) Pub. No.: US 2016/0097625 A1
(43) Pub. Date: Apr. 7, 2016

(54) ADJUSTABLE INSTRUMENT FOR MEASURING, DETERMINING AND MARKING TWO OR MORE HORIZONTAL OR VERTICAL POINTS AND METHOD OF USE OF SAME

(71) Applicant: Thomas Scott Dykes, Peoria, AZ (US)

(72) Inventor: Thomas Scott Dykes, Peoria, AZ (US)

(21) Appl. No.: 14/868,144

(22) Filed: Sep. 28, 2015

Related U.S. Application Data
(60) Provisional application No. 62/058,601, filed on Oct. 1, 2014.

(51) Int. Cl. G01B 3/10; G01C 9/34

(52) U.S. Cl. CPC G01B 3/1084; G01C 9/34; G01B 2003/1089; G01B 2003/1092

(57) ABSTRACT

Disclosed herein is an adjustable instrument for the measuring, determining and marking of two or more horizontal or vertical points that allow precise spacing, alignment and leveling between points on a surface. The instrument includes a flexible tape strip member with markings to indicate distance measurements, a level member attached parallel to the length of the tape strip, a fastening member such as thumbtacks which serve to mark the tape strip member at various positions to indicate the desired spacing or distance between points and further serves to mark the position of the points. The tape strip member is used to measure the desired spacing between points. The fastening member is then used to pierce the tape strip, thereby marking the position of the points. The tape strip member with the attached fastening members are then taken to a surface such as a wall where one of the fastening members is driven into the wall. The level member assists in enabling the user to position the second fastening member so that the tape strip will be in a perfect horizontal or vertical plane from the first fastening member. The temporary fastening members mark the points on the surface where a permanent fastening implement or hanging appliance such as a nail, screw, anchor or other fastening implement can be inserted.

### 1. FIELD OF THE INVENTION

The present disclosure relates generally to the field of geometric instruments, more particularly the determination of precise horizontal and vertical points on a surface plane such as a wall. The device facilitates the centering and hanging of an object on a surface plane and more specifically, it relates to determining the placement of fasteners, such as nails, screws, pegs, mollies, hooks, and bull hooks, for hanging pictures, frames, shelving, carpets, sculptures, cabinets, decorative objects and the like on a given surface plane.

### 2. SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

The present invention provides a simple, reliable and affordable device to measure, determine and mark two or more points on a horizontal or vertical plane on a surface such as a wall.

In particular, the invention relates to a device and method of using same which enables the measurement and location of two or more perfectly level horizontal points or two or more perfectly level vertical points on a surface such as a wall. The device has application in the hanging of picture frames and shelving or in any other endeavor where it is necessary to locate two or more points precisely on a horizontal line or on a vertical line.

The disclosed embodiment of the device is a hand-held implement comprised of two or more temporary fasteners and one or more levels combined with a length of flexible and durable tape strip marked with distance indicators. In this embodiment, it is possible to utilize the device using only one hand.

The tape strip member function as a flexible yet durable means of holding the level, measuring the distance between points and marking the position of the desired points.

The temporary fastener member may be but need not be thumbtacks or their equivalent.

The level member may be but need not be a spirit or liquid level.

The level member assists in leveling the horizontal or vertical position of the tape strip member.

The temporary fasteners function to mark the position of the points which the user desires to position in a horizontal or vertical plane and also serves the function of securing or fastening the tape strip member to the surface. The temporary fasteners serves as an adjustable means for marking the tape strip member and as a securing means capable of temporarily holding the tape strip to the surface being measured or where the points will be placed.

It is a feature of the invention that, in use, the device falls away once one of the temporary fasteners is removed from the wall but the other remaining temporary fastener remains attached or inserted into the wall holding the tape strip, thereby marking the location of the second point. This allows the user to locate the first point, insert the appropriate permanent fastening implement or hanging appliance (nail, screw, anchor, etc.) and then easily locate the second point.

It is an additional feature of the invention that it is not limited to flat walls but can also be used on curving walls. The device will function in the same way to locate two or more points precisely on a horizontal line or on a vertical line on a curved wall as it would on a flat wall.

The invention can be of any length since it is a flexible tape strip. It is thus not limited in length.

The device will accommodate both right-handed and left-handed users.

Although the invention is illustrated and described herein as embodied in a tool for hanging an object, it is nevertheless not intended to be limited to the details shown as various modifications and structural changes may be made therein without departing from the spirit of the invention and would be within the scope and range of equivalents of the claims. The construction of the invention, however, together with the advantages thereof, will be best understood from the following description of specific embodiments when read in connection with the accompanying drawings.

### 3. DESCRIPTION OF RELATED ART

Hanging picture frames and other items on a wall such as shelving, mirrors or decorations often require more than one hook or fastener to be used. Where two or more spaced hooks or fasteners are required, there is often difficulty in setting the spacing and determining that the hooks or fasteners are of the same height (in line with each other). If the position of the hook or fasteners are not horizontally level to each other (one hook is either higher or lower than the other), the object being hung will hang at an angle. One or more of the hooks or fasteners will need to be removed and re-inserted into the wall to achieve a balanced or level position. Much trial and error resulting in frustration or tediousness could result as well as damage to the wall or other surfaces.

Similarly, if a wire is to be attached to the rear of a frame or flat object to be hung on a surface, the two attachment points of the wire will need to be levelly placed to ensure that the object will be aligned straight when hung from the wire.

It is the object of the present invention to provide a device and a method of use that facilitates the easy and accurate determination of two or more points on a horizontal or vertical plane. This application is useful for hanging single objects on a wall or for hanging multiple objects on a wall in a line. It can be further used to determine the level placement of attachment points on the surface of a flat object being hung. This application is also useful for determining straight lines on a wall for painting purpose, window and door positioning purposes and other architectural, carpentry or renovation uses.

It is an object of the invention to provide a device and a method of use that can be utilized by any person for hanging objects on a wall regardless of the person's lack of experience or skill in this art.

It is also the object of the invention to allow those without knowledge of how measurements and how to read a ruler to levelly hang objects on a wall.

Other leveling devices or hanging aides may achieve the same end result, however they are more complicated or difficult to use, are more costly to produce, require more space to store or are limited in their functionality.

There are many devices that incorporate levels and straight edge rulers. Rulers have the disadvantage of being limited in their length so that the maximum distance between points is dictated by the length of the ruler. The ruler, especially if it is of longer length may be heavy and cumbersome to handle and use. Also, once no longer in use, rulers require much space to store. Additionally, these devices utilizing straight rulers can not mark positions on a curved wall.

The present invention consists of a tape strip made of flexible and light material such as nylon on fabric, Teflon coating or other durable materials so that the strip can be rolled up. The tape strip can be a much greater length than a ruler and can be more easily handled and stored. Its small storage size and light weight makes it suitable for tool boxes or pockets. Also, the present invention can be used to mark points on a curved surface. The invention is also much cheaper to produce since it consists of very simple components.

It is a further object of the invention to allow the user to mark the position of horizontally or vertically level points on the wall or other surface without the need to wield a heavy or cumbersome device at the same time. Most of the devices in the art require the user to hold onto the ruler or level while the user attempts to mark the positions on the wall. The invention, in contrast, is temporarily fastened to the wall, thereby freeing the user's hands.

The invention can be left in place on the wall indefinitely until the user is ready to insert the permanent fastening implements or hanging appliances (nails, screws, anchors, etc.) to the wall or surface.

There are some devices that have a means of marking or notching the wall to indicate the position of a fastener. However, these marks or notches are often difficult to locate once a person steps away from a wall. In a situation where a person uses such a device to mark two or more points on a wall, once he inserts a fastener into one position, there is nothing but a faint marking or notch to indicate where the second or subsequent positions are.

This present invention overcomes these problems by simply being fastened to the wall by two or more thumbtacks or other fastener and remaining in position to mark the points until the user is ready to insert the fasteners. The ease of use for this invention and its ability to visually mark the points on the surface also means that objects can be hung more quickly.

There are flexible leveling devices in the art, however they lack a means for the device to be temporarily attached to the wall to indicate the location of the marked points. These devices face the same problem wherein the user needs to hold the device level while attempting to mark the points with a pencil. Once the user puts down the device and locates his hammer, screwdriver or drill, the user will have a difficult time re-locating the marks on the wall. Whereas with the present invention, the device remains attached to the wall until the user has inserted all the necessary fasteners into the wall.

The other devices in this field consists of plastic casing, springs, metal measuring tapes, rulers made of wood and other materials or complex mechanisms to achieve a similar result to the present invention. These devices would be costlier to produce, weigh more thereby increasing shipping costs and would require more packaging materials at a greater cost and take up more retail space than the present invention. The present invention does not contain any complex mechanisms or expensive materials. It is simply a flexible yet durable tape strip, a level attached to the tape strip and two or more thumbtacks. The device can be rolled up into a small box or package, minimizing packaging costs and maximizing utilization of retail space.

In view of the foregoing, there exists a need for a simple, fast, affordable, flexible, compact and durable means (e.g., devices and/or methods) that allow the measurement and determination of two or more horizontal or vertical points on a surface.

### 4. DETAILED DESCRIPTION

The detailed description provided below in connection with the drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

For convenience, certain terms employed in the entire application (including the specification, examples, and appended claims) are collected here. Unless otherwise defined herein, scientific and technical terminologies employed in the present disclosure shall have the meanings that are commonly understood and used by one of ordinary skill in the related art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

According to one embodiment of the present disclosure, the device comprises a flexible tape strip member bearing markings on one side indicating distance measurements, one level member attached parallel to the tape strip member at the center of the tape strip and two piercing fastening members which can be household thumbtacks.

The markings on the tape strip member in this embodiment consists of a continuous line proceeding through the center (centerline) down the length of the tape strip member. The markings are on one side of the tape strip member. The continuous horizontal line down the length of the strip is intersected at a ninety-degree angle at one-inch intervals by short vertical lines, each spanning the width of the strip. The markings do not have numbers as on a ruler so as to make the device useable by persons who do not understand how to read a ruler. This embodiment allows for accurate measurement and location on a surface of two or more points on a level horizontal plane.

According to various embodiments of the present invention, the method of using the device as embodied in the present disclosure to hang an object such as a shelf on a wall comprises the following steps (with thumbtacks used as the fastening member for illustration purposes, although other fasteners may be utilized):
(a) The user lines up the tape strip with the holes on the back of the shelf where the shelf will attach to the wall, making sure that the pre-attached level is in between the holes. The side with the markings should be facing up towards the user.
(b) The user places one thumbtacks (or other fastener) at the center of each of these hole locations, piercing the tape strip. The tape strip should be pierced on the continuous line marking running the length of the tape strip to insure correct positioning. The thumbtacks should pierce the tape strip on either side of the attached level. The thumbtacks now marks the locations on the strip corresponding to the spacing between the holes on the shelf to be hanged.
(c) The use then takes the tape strip with the two thumbtacks piercing it to the wall where the user intends to hang the shelf. The user determines the desired height to hang the shelf.
(d) The user drives in one thumbtack with the attached end of the tape strip into the wall,
(e) The user stretches out the other end of the tape strip with the other thumbtack along the wall until the strip is taut. Using the attached level, the user positions the thumbtack at a horizontal level plane to the first thumbtack.
(f) Making sure that the tape strip remains taut and that the level member indicates that it is level, the user then drives the other thumbtack into the wall,
(g) The user then prepares the nails, screws or anchors (the fastening implements) that will be used to hang the shelf.
(h) The user pulls out the first thumbtack on the other end, leaving the second thumbtack embedded. The free end of the tape strip falls away and is now hanging by that first thumbtack only, marking the location of the subsequent hole. The first thumbtack remains piercing the dangling end of the tape strip.
(i) The user drives the nail, screw or anchor into the hole left by the first thumbtack,
(j) The user then prepares the second nail, screw or anchor.
(k) The user moves over to the second thumbtack which is still attached to the wall and pulls it out.
(l) The tape strip is now free and can be placed on the floor or somewhere else that is safe.
(m) The user drives the second nail, screw or anchor into the hole left by the second thumbtack.
(n) The user now has two nails, screws or anchors at the precise distance for the holes behind the shelf and positioned perfectly horizontal to each other.
(o) The user can now bring the shelf over to the wall, align the holes in the back of the shelf to the nails, screws or anchors, position the shelf to align with the installed fastening implements and attach the shelf.

According to various embodiments of the present invention, the method of using the device as embodied in the present disclosure to hang a picture frame on a wall, step (a) in the list of steps above is replaced with:
(a1) The user lines uses the tape strip to line up with the location of the attachment slots on the back of the picture frame, making sure that the pre-attached level is in between the holes.

According to various embodiments of the present invention, the method of using the device as embodied in the present disclosure to find two perfectly level points on a horizontal plane, comprises the following steps:
(a2) The user uses the markings on the tape strip to determine the desired length between the two points.
(b2) The user than pierces the tape strip with one thumbtack to mark the start and a second thumbtack to mark the end of the desired length, making sure that the pre-attached level is in between these two points. The tape strip should be pierced as precisely on the continuous line marking running the length of the tape strip as possible to insure correct alignment.
(c2) The user then takes the tape strip with the two thumbtacks piercing it to the wall where the user intends to mark the two points. The user determines the desired height for the points.
(d2) The user drives in one thumbtack with the attached end of the tape strip into the wall.
(e2) The user stretches out the other end of the tape strip with the other thumbtack along the wall until the strip is taut. Using the attached level, the user positions the thumbtack at a horizontal level plane to the first thumbtack.
(f2) Making sure that the tape strip remains taut and that the level member indicates that it is level, the user then drives the other thumbtack attached to the other end of the strip into the wall.
(g2) The user now has two points on the wall which are perfectly level on a horizontal plane. The user can remove each thumbtack and draw a line between the points using a ruler or other tool.
(h2) The resulting placement of the points on the wall has application in marking the location of where to cut through a wall to install an opening as for a window or door, for marking a perfectly level line for painting purposes or for any other use where it is desirable to have two or more points on a level line.

According to various embodiments of the present invention, the method of using the device as embodied in the present disclosure to find more than two perfectly level points on a horizontal plane, comprises the following steps:
(a3) The user uses the markings on the tape strip to determine the placement of the desired number of points on the tape strip.
(b3) The user than pierces the tape strip with one thumbtack to mark each point, making sure that the pre-attached level is in between two of these points. The tape strip should be pierced on the continuous line marking running the length of the tape strip to insure correct positioning.
(c3) The user then takes the tape strip with the thumbtacks piercing it to the wall where the user intends to mark the points. The user determines the desired height for the points.
(d3) The user selects one of the attached thumbtacks closest to the attached level and drives in one thumbtack with the attached end of the tape strip into the wall.
(e3) The user stretches out the other end of the tape strip with the other thumbtacks along the wall until taut. Using the attached level, the user positions the thumbtack on the other side of the attached level at a horizontal level plane to the first thumbtack.
(f3) Making sure that the tape strip remains taut and that the level member indicates it is level, the user then drives the next thumbtack into the wall.
(g3) The user then moves to the next location on the tape strip where the next thumbtack pierces it. Making sure that the tape strip is taut and flat against the wall, the user drives the next thumbtack into the wall.
(h3) The user repeats the immediately preceding step until all thumbtacks that are attached to the tape strip on either side of the level are driven into the wall.
(i3) The user now has now marked three or more points on the wall which are perfectly level on a horizontal plane.

According to one optional embodiment, the level is attached perpendicular to the tape strip, enabling measurement and location of two or more vertical points in a plane.

According to various embodiments of the present invention, the method of using the device as embodied in the optional embodiment where the level is attached perpendicular to the length of the tape strip to find two or more perfectly level points on a vertical plane comprises the following steps:
(a4) The user uses the markings on the tape strip to determine the (placement of the desired number of points on the tape strip.
(b4) The user then pierces the tape strip with one thumbtack to mark each point, making sure that the pre-attached level is in between the last two points on one end of the tape strip. The tape strip should be pierced on the continuous line marking running the length of the tape strip to insure correct positioning.
(c4) The user then takes the tape strip with the thumbtacks piercing it to the wall where the user intends to mark the points. The user determines the desired location for the points along the wall.
(d4) The user selects one of the attached thumbtacks closest to the attached level and drives in one thumbtack with the attached end of the tape strip into the highest point desired on the wall.
(e4) The tape strip will hang down from the attached thumbtack that was driven into the wall. The user stretches out the other end of the tape strip with the other thumbtacks down the wall until it is taut. Using the attached level, the user positions the thumbtack at a vertical level plane to the first thumbtack.
(f4) Making sure that the tape strip is taut and flat against wall and that the level member indicates it is level, the user then drives the thumbtack on the other side of the level into the wall.
(g4) If there are only points marked by two thumbtacks on the tape strip, the user now has two points on the wall which are perfectly level on a vertical plane.
(h4) If the user had marked more than two points on the tape strip with additional thumbtacks, the user will move on to the next thumbtack and making sure that the tape is taut and flat against the wall, drive the next thumbtack into the wall.
(i4) The user repeats the immediately preceding steps for all remaining attached thumbtacks.
(j4) The user now have a series of points on the wall which are perfectly level on a vertical plane. This is useful for hanging larger objects that have more than two points of attachment or for hanging multiple objects in a level row along a wall.

According to the principles and spirit of the present disclosure, the method of marking two vertical points above can be extended to mark more than two vertical points.

In certain optional embodiments, the level may be on a swivel so that it can be rotated to align parallel to the tape strip for locating horizontal points or aligned perpendicularly to the tape measure for locating vertical points.

In certain optional embodiments, more than one level is attached to the tape strip member at various points on the tape strip.

In certain optional embodiments, one level is attached parallel to the tape strip member and a second level is attached a distance along the tape strip at a perpendicular alignment to the tapes trip.

According to certain optional embodiments of the present disclosure, the temporary fastener members may be other types of piercing fasteners other than thumb tacks while other optional embodiments may use non-piercing fastener members such as mounting putty or other re-usable adhesives.

According to some optional embodiments of the present disclosure, the tape strip member may be of various lengths.

According to some optional embodiments of the present disclosure, the space markings on the tape strip member may consist of various measuring standards, notations and systems such as the metric measurement systems.

According to some optional embodiments of the present disclosure, the tape strip may be of various lengths and the space markings on the tape strip may consist only of lines or alternatively, of lines with numbers such as on a ruler or measuring tape.

According to other optional embodiments of the present disclosure, the markings on the tape strip member of the invention are on both sides of the tape strip.

According to other optional embodiments of the present disclosure, there are no markings on the tape strip component of the invention.

According to other optional embodiments of the present disclosure, the tape strip component of the invention is comprised of various materials but retains the property of flexibility.

According to other optional embodiments of the present disclosure, the means of marking the points on the tape strip and attaching the tape strip to the surface may utilize alternative piercing implements other than thumbtacks as in the present embodiment.

In other non-limiting examples of the present disclosure, the level member attached to the tape strip member may be of various sizes.

In other non-limiting examples of the present disclosure, the level member attached to the tape strip member may be of different functionality.

According to other optional embodiments of the present disclosure, more than one level may be attached to the tape strip member.

The device as in the current embodiment may be used in combination with devices according to other optional embodiments.

In yet another aspect, the present invention is directed to a method for marking diagonal lines on a surface.

According to various embodiments of the present invention, the method of using two devices in combination for the purpose of marking a ninety-degree angle on a surface, comprises the following steps:
(a5) In this example, the user uses two differing embodiments of the invention: one tape strip where the level is attached parallel with the length of the tape strip and one tape strip where the level is attached perpendicular to the length of the tape strip.
(b5) Taking the tape strip with the parallel level, the user uses the markings on the tape strip to determine the desired distance t en two points.
(b2) The user than pierces the tape strip with one thumbtack to mark each point, making sure that the pre-attached level is in between these two points. The tape strip should be pierced as precisely on the continuous line marking running the length of the tape trip as possible to insure correct positioning.
(c5) The user than takes the tape strip with the perpendicularly attached level and determines the desired distance between two points.
(d5) The user than pierces the tape strip at the desired point with the same thumbtack that is already piercing one end of the parallel level tape strip. That thumbtack is now piercing two tape strips.
(e5) The user than marks the other point on the tape strip with the parallel level by piercing it with a thumbtack, making sure that the pre-attached level is in between this new point and the point previously marked by the thumbtack which is also piercing the tape strip with the perpendicular level.
(f5) The user then takes these two tape strips with the three thumbtacks piercing them to the wall where the user intends to mark the points. The user determines the desired height and alignment for the points along the wall.
(g5) The user drives into the wall the thumbtack that is piercing both tape strips.
(h5) The user stretches out the other end of the tape strip with the parallel level along the wall until it is taut. Using the attached level, the user positions the thumbtack at a horizontal level plane to the first thumbtack piercing both tape strips.
(i5) Making sure that the tape strip is taut and that the level member indicates it is level, the user then drives this other thumbtack into the wall.
(j5) The user than stretches out the other end of the tape strip with the perpendicular level down the wall vertically until it is taut. Using the attached level, the user positions the remaining thumbtack at a perfect vertical plane to the first thumbtack.
(k5) Making sure that the tape strip remains taut and that the level member indicates it is level, the user then drives the other thumbtack into the wall.
(l5) The user now has three points on the wall which constitute a perfect 90 degree angle. The arrangement may look like an “L” depending on the orientation of marks chosen. If the points were all equidistant, the points will constitute a perfect right angle triangle. A diagonal line can be drawn between the two points at the end of the two tape strips.

It will be understood that the above description of embodiments is given by way of example only and that various modifications may be made by those with ordinary skill in the art. The above specification, examples, and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

Many of the attendant features and advantages of the present disclosure will becomes better understood with reference to the following detailed description considered in connection with the accompanying drawings.

### 5. BRIEF DESCRIPTION OF THE DRAWINGS

The present description will be better understood from the following detailed description read in light of the accompanying drawings, where:

FIG. 1 is a schematic diagram illustrating an adjustable device for measuring, determining and marking two or more horizontal points and two thumbtacks, according to one embodiment of the present disclosure. The tape strip member can be of various lengths;

FIG. 2 is a front facing schematic diagram illustrating the invention with two thumbtacks piercing and inserted into the tape strip member and a level member attached parallel to the length of the tape strip member;

FIG. 3 is a perspective view schematic diagram illustrating the invention with two thumbtacks piercing and inserted into the tape strip member and a level member attached parallel to the length of the tape strip member;

FIG. 4 is a front facing schematic diagram illustrating an adjustable device for measuring, determining and marking two or more vertical points with the level member attached perpendicular to the tape strip member and two thumbtacks inserted into the tape strip member, according to one embodiment of the present disclosure;

FIG. 5 is a perspective view schematic diagram illustrating the invention with two thumbtacks piercing and inserted into the tape strip member and a level member attached perpendicular to the length of the tape strip member;

FIG. 6A is a perspective view illustrating how a user would use the tape strip member to determine the points where the thumbtacks should be inserted. The view has one end of the tape strip member pierced by one thumbtack and the user in the process of piercing the other end of the tape strip member with the other thumbtack;

FIG. 6B is a perspective view illustrating how the device is set against a wall and one of the thumbtacks driven into the wall. The user in this illustration has pulled taut the tape strip member and is using the attached level member to achieve a horizontal level plane;

FIG. 6C is a perspective view of the device where the tape strip member is attached at two points to a wall with the level in between the points;

FIG. 6D is a perspective view of the device where the user has pulled out one thumbtack, leaving an obvious hole in the wall. The remaining thumbtack remains inserted into the wall marking the second point while the tape strip member has fallen away;

FIG. 6E is a perspective view illustrating the user inserting a screw into the wall at the location of the obvious and visible hole left by the first thumbtack. The remaining thumbtack and tape strip member dangling from the wall marks where the second screw show be inserted;

FIG. 6F is a perspective view of the wall or surface after the remaining thumbtack has been removed, leaving another obvious and visible hole;

FIG. 7 is a front facing schematic diagram illustrating the invention with two thumbtacks at a distance from each other along the length of the tape strip member on one side of the level member, thereby marking three horizontal points;

FIG. 8 is a front facing schematic diagram illustrating two thumbtacks at a distance from each other along the length of the tape strip member on either side of the level member, thereby marking four horizontal points;

FIG. 9 is a front facing schematic diagram illustrating the use of two embodiments of the invention together for the purpose of marking three points at a perfect right angle to each other;

FIG. 10 is a perspective schematic diagram illustrating the invention with two level members attached, one attached parallel to the length of the tape strip member and one attached perpendicular to the length of the tape strip member, according to one embodiment of the present disclosure;

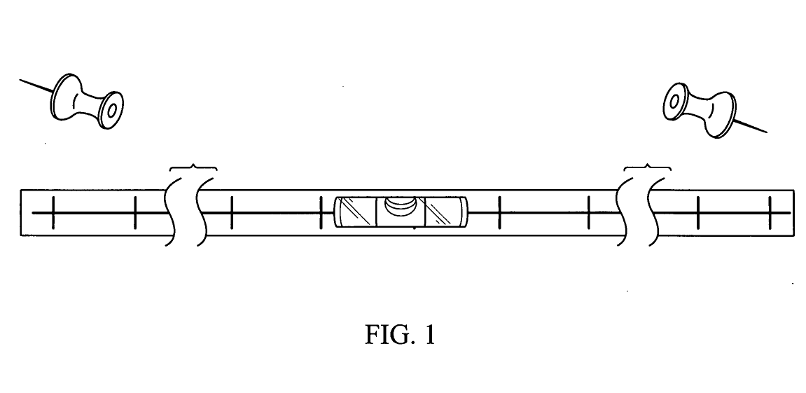

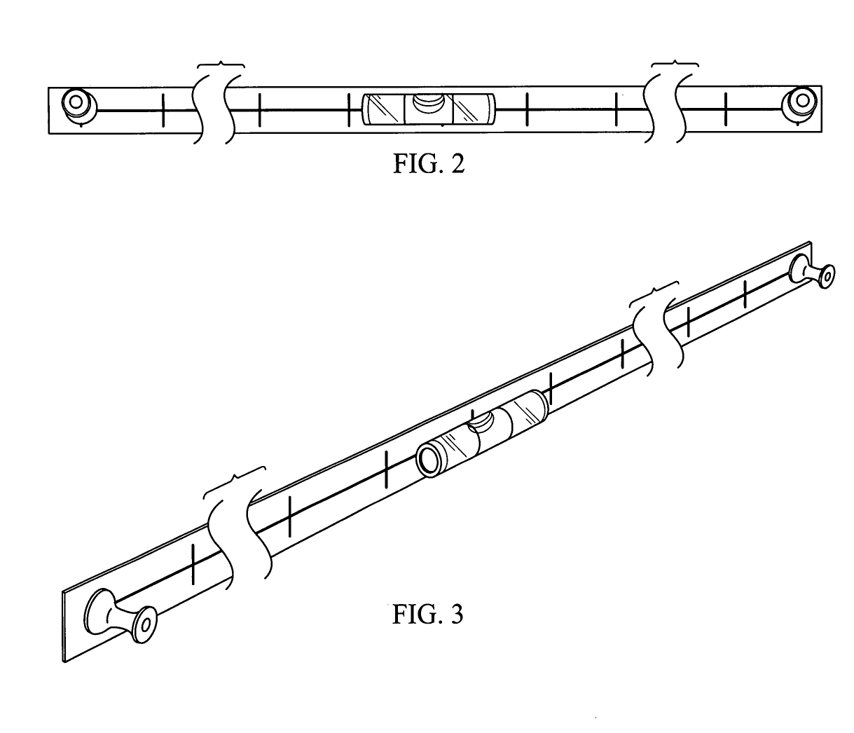

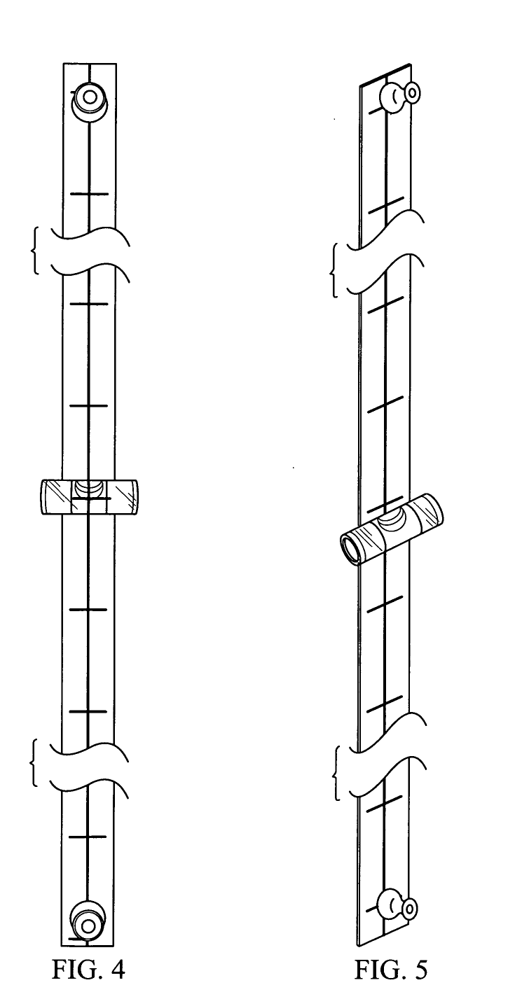

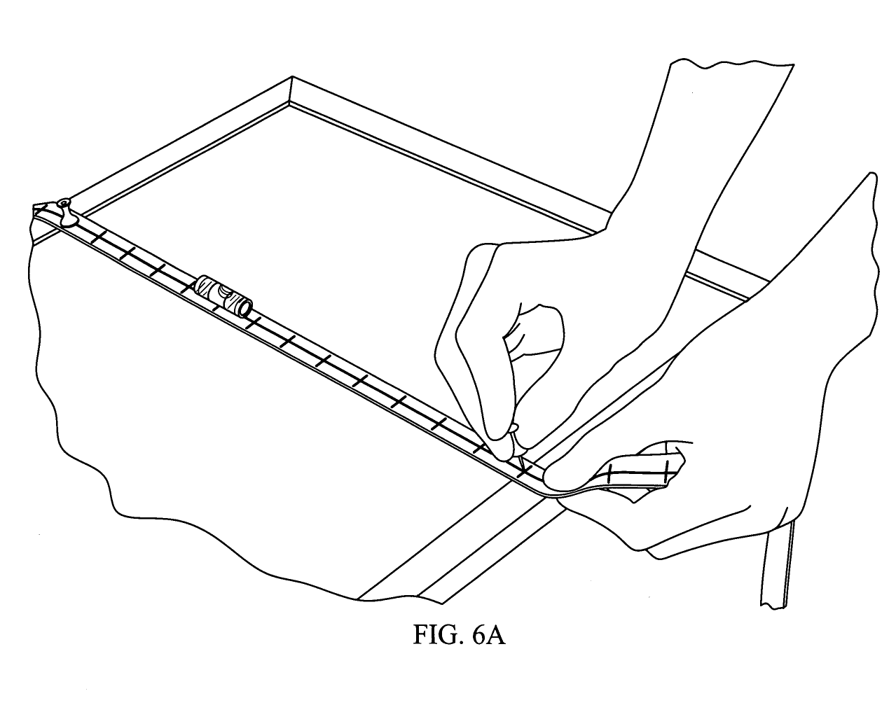

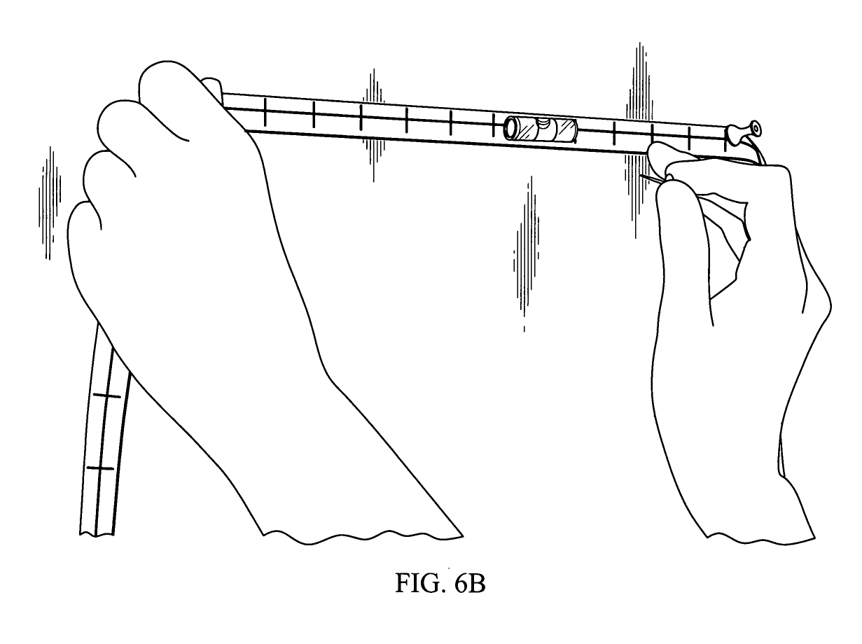

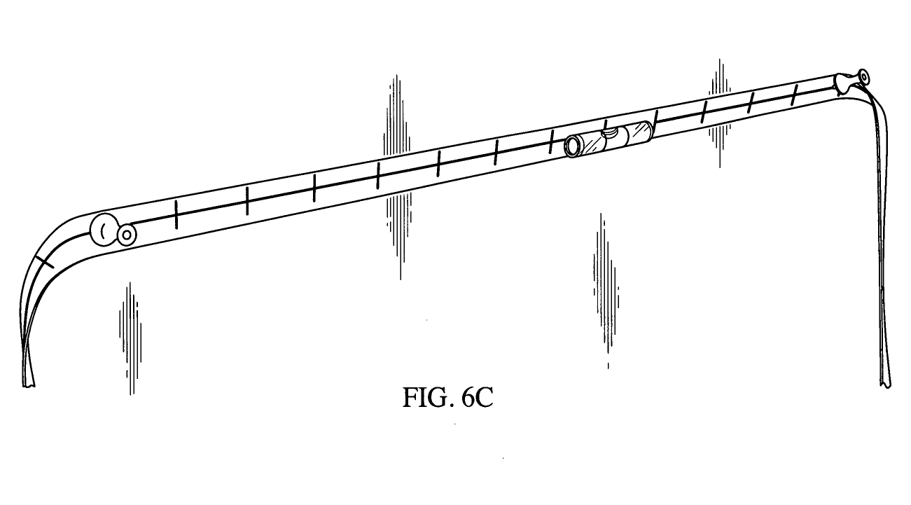

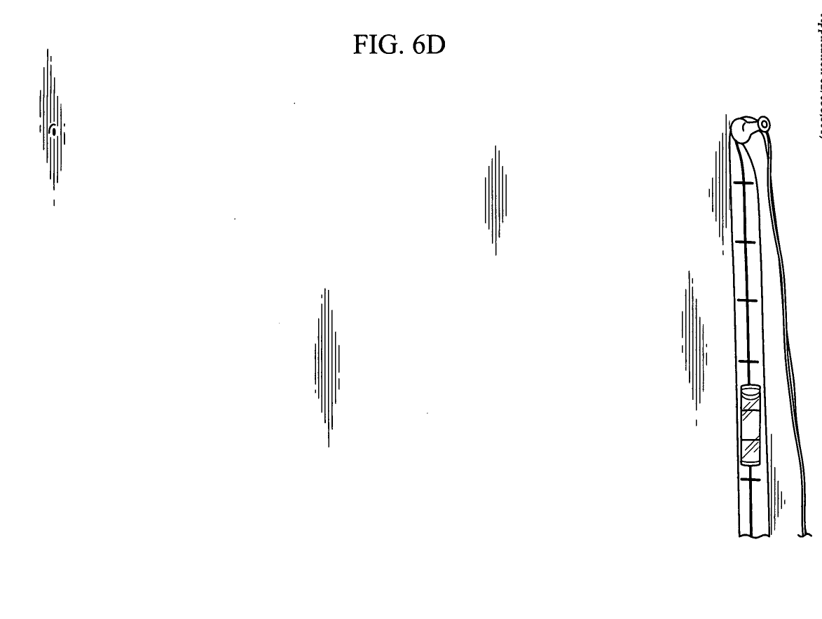

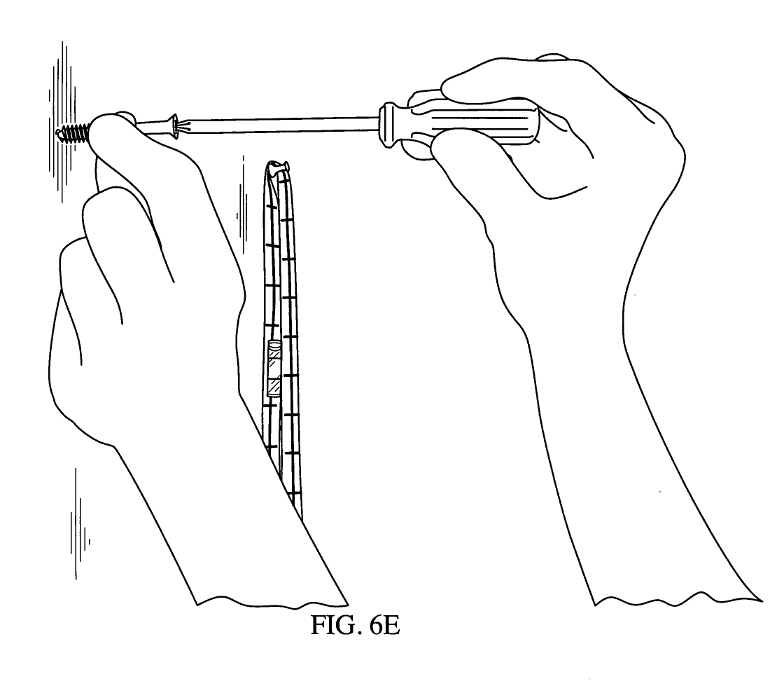

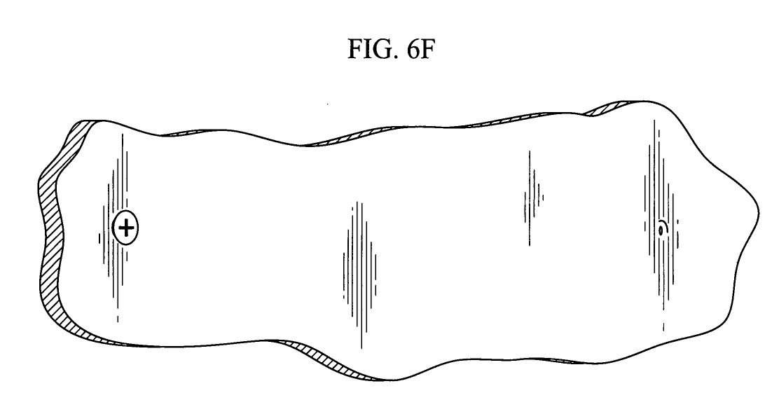

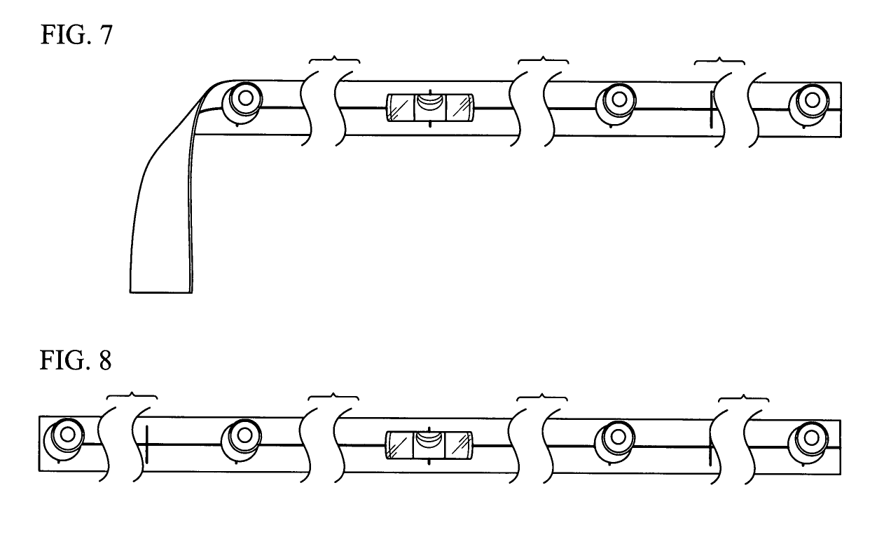

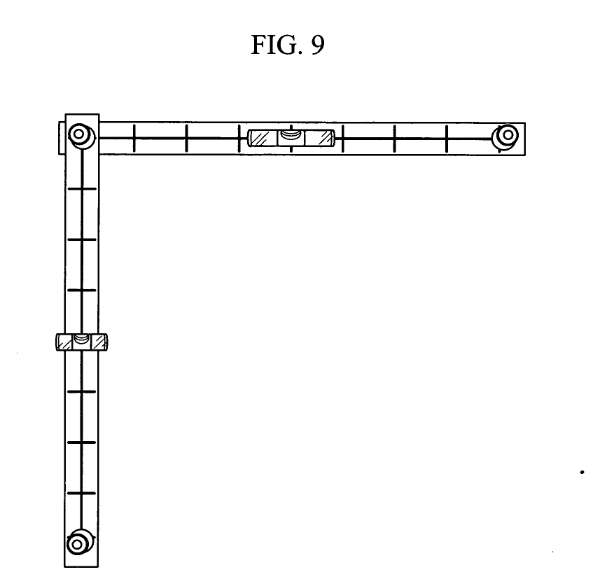

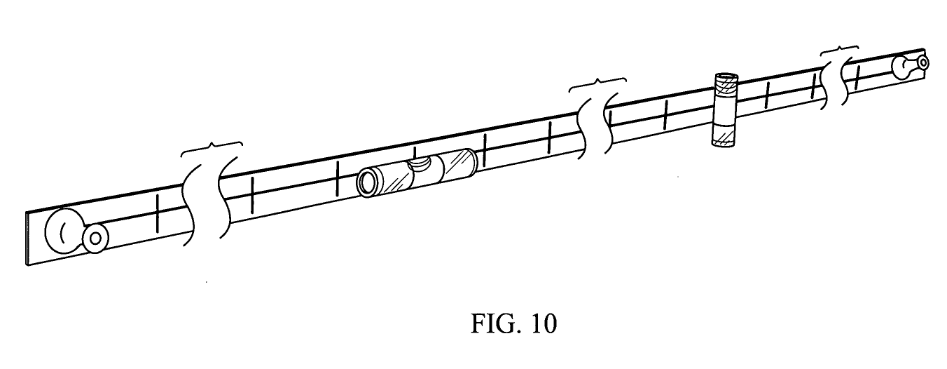

In accordance with common practice, the various described features/elements are not drawn to scale but instead are drawn to best illustrate specific features/elements relevant to the present invention. Also, like reference numerals and designations in the various drawings are used to indicate like elements/parts.

What is claimed is:

1. An adjustable instrument for measuring, determining and marking two or more horizontal or vertical points, comprising,
a flexible tape strip member with markings to indicate distance measurements;
a level member attached parallel to the length of the tape strip;
a fastening member such as thumbtacks which serve to mark the tape strip member at various positions to indicate the spacing between points and further serve to mark the position of the points on a surface. These fastening members also function to attach the ends of the tape strip to the surface;

2. The adjustable instrument of claim 1, wherein the level member is attached perpendicular to the length of the tape strip member;

3. The adjustable instrument of claim 1, wherein the level member is attached to the tape strip member on a swivel so that it can be orientated either parallel or perpendicular to the length of the tape strip member;

4. The adjustable instrument of claim 1, wherein one level is attached parallel to the length of the tape strip member and a second level is attached perpendicular to the length of the tape strip member.

5. The adjustable instrument of claim 1, wherein there is a plurality of levels members attached in differing orientations relative to the length of the tape strip member;

6. The adjustable instrument of claim 1, wherein the level members are of different sizes;

7. The adjustable instrument of claim 1, wherein the tape strip member is marked with measurements and numbers;

8. The adjustable instrument of claim 1, wherein the tape strip member is marked on both sides.

9. The adjustable instrument of claim 1, wherein the tape strip member contain no markings;

10. The adjustable instrument of claim 1, wherein the fastening members are alternative piercing implements other than thumbtacks;

11. The adjustable instrument of claim 1, wherein the fastening members are reuseable adhesives.

11. A method for using the adjustable instrument of claim 1 comprising the steps of:
(a) The user uses the tape strip member to determine the desired length between two or more points;
(b) The user than pierces the tape strip with one thumbtack to mark each point, making sure that the pre-attached level is in between two of the points. The tape strip should be pierced on the continuous line marking running the length of the tape strip to insure correct positioning;
(c) The user then takes the tape strip with the thumbtacks piercing it to the surface where the user intends to mark the points. The user determines the desired height for the points;
(d) The user drives in one thumbtack with the attached end of the tape strip into the wall;
(e) The user stretches out the other end of the tape strip with the other thumbtack along the wall until it is taut. Using the attached level, the user positions the thumbtack at a horizontal level plane to the first thumbtack;
(f) Making sure that the tape strip remains taut and that the level member indicates it is level; the user then drives the other thumbtack into the wall;
(g) If there are only two points marked by two thumbtacks on the tape strip, the user now has two points on the wall which are perfectly level on a horizontal plane;
(h) If the user had marked more than two points on the tape strip, the user will move on to the next thumbtack away from the level and making sure that the tape is taut and flat against the wall, drive the next thumbtack into the wall;
(i) The user repeats the immediately preceding steps for all remaining attached thumbtacks;
(j) The user now have a series of points on the wall which are perfectly level on a horizontal plane;
(k) The user pulls out the first thumbtack on the one end, leaving the other thumbtacks embedded. The free end of the tape strip falls away and is now hanging by the other thumbtack or thumbtacks. The first thumbtack remains attached to the tape strip;
(l) The user drives the nail, screw, anchor or other fastening implement into the hole left by the first thumbtack;
(m) The user then prepares the second nail, screw or anchor.
(n) The user moves over to the next thumbtack which is still attached to the wall and pulls it out;
(o) The user drives the second nail, screw or anchor into the hole left by the second thumbtack;
(p) If there are additional thumbtacks, the user will remove each subsequent thumbtack and repeats steps (m) to (o);
(q) Once the last thumbtack is removed from the wall, the tape strip is now free and can be placed on the floor or somewhere safely out of the way;
(r) The user now has a number of nails, screws or anchors at a precise distance and spacing positioned perfectly horizontal to each other;

11. The method of claim 10 wherein instead of measuring points on a horizontal plane, the device according to other optional embodiments is used to measure points on a vertical plane.

12. The method of claim 10 wherein two or more devices, including those in optional embodiments, are used in combination in order to measure and determine points at precise angles to each other.
